(19) United States
(12) Patent Application Publication
(10) Pub. No.: US 2024/0052678 A1
(43) Pub. Date: Feb. 15, 2024

(54) EMERGENCY DOOR LOCK

(71) Applicant: Rick Metherd, Littleton, CO (US)

(72) Inventor: Rick Metherd, Littleton, CO (US)

(21) Appl. No.: 17/819,659

(22) Filed: Aug. 15, 2022

(51) Int. Cl. E05C 19/18

(52) U.S. Cl. CPC E05C 19/188

(57) ABSTRACT

An emergency door lock includes a sleeve with a length between a first end having a first edge and a second end having a second edge. Fastened adjacent to at least one of the first and second ends is a strap extending from a strap proximal end to a strap distal end. A method for manufacturing an emergency door lock includes providing a sleeve having a length between a first end having a first edge and a second end having a second edge and, adjacent to at least one of the first and second ends, fastening a strap which extends from a strap proximal end to a strap distal end.

### TECHNICAL FIELD

The present disclosure pertains to securing doors against unauthorized entry.

### SUMMARY

The disclosure describes an emergency door lock. The emergency door lock includes a sleeve with a length between a first end having a first edge and a second end having a second edge. Fastened adjacent to at least one of the first and second ends is a strap extending from a strap proximal end to a strap distal end.

The disclosure also describes a method for manufacturing an emergency door lock. The method for manufacturing an emergency door lock includes cutting a plurality of segments from a fire hose and coupling a pull strap to the fire hose. Each of the segments has a first end with a first edge and a second end with a second edge. The pull strap is coupled to the fire hose adjacent to at least one of the first and second edges.

The disclosure also describes another method for manufacturing an emergency door lock. The method includes providing a sleeve having a length between a first end having a first edge and a second end having a second edge and, adjacent to at least one of the first and second ends, fastening a strap which extends from a strap proximal end to a strap distal end.

### BRIEF DESCRIPTION OF THE FIGURES

The summary above, as well as the following detailed description of illustrative embodiments, is better understood when read in conjunction with the appended drawings. For the purpose of illustrating the disclosure, example constructions are shown in the drawings. However, the disclosure is not limited to specific methods and instrumentalities disclosed herein. Moreover, those having ordinary skill in the art will understand that the drawings are not to scale. Wherever possible, like elements have been indicated by identical numbers.

Embodiments of the disclosure will now be described, by way of example only, with reference to the following diagrams wherein:

FIG. 1 illustrates a top view of an example emergency door lock.

FIG. 2 illustrates a bottom view of the example emergency door lock of FIG. 1.

FIG. 3 illustrates a front view of the example emergency door lock of FIGS. 1 & 2.

FIG. 4 illustrates a right side view of the example emergency door lock of FIGS. 1-3.

FIG. 5 illustrates a left side view of the example emergency door lock of FIGS. 1-4.

FIG. 6 illustrates a cross-section of an example emergency door lock.

FIG. 7 illustrates an example emergency door lock in use with an example door.

### DETAILED DESCRIPTION

The following detailed description illustrates embodiments of the disclosure and manners by which they can be implemented. Although the best mode of carrying out disclosed systems, apparatuses and methods has been described, those of ordinary skill in the art would recognize that other embodiments for carrying out or practicing disclosed systems, apparatuses and methods are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Recent tragic events at businesses, industrial sites and institutional sites such as schools, hospitals and grocery stores call for forms of heightened security. In many cases, lives could be saved and/or injuries prevented by securing a door between an attacker and potential victims. However, most door locks require an amount of manual dexterity that may not be available due to emotional and physical responses to an emergency. Further, some door locks may be broken with a tool or firearm. Simplifying the actions needed to secure a door against an attacker in a manner not easily overcome by force promises greater safety during violent intruder scenarios.

Embodiments of the disclosure substantially eliminate, or at least partially address, problems in the prior art, enabling a user, with a few simple movements, to quickly lock a door in a way that cannot easily be overcome by force.

Additional aspects, advantages, features and objects of the disclosure will be made apparent from the drawings and the detailed description of the illustrative embodiments construed in conjunction with the appended claims that follow. It will be appreciated that described features are susceptible to being combined in various combinations without departing from the scope of the disclosure as defined by the appended claims.

Businesses, industrial sites and institutional sites often have heavily-constructed doors with a door closer or self-closer having a first link pivotably coupled with a structural element such as the door frame at its first end and a second link pivotably coupled with the door at its first end wherein the first and second arms are pivotably coupled at their second ends to form an elbow. A spring and/or damper at the coupling between the door and the second arm allows the door to close in a controlled manner to prevent slamming.

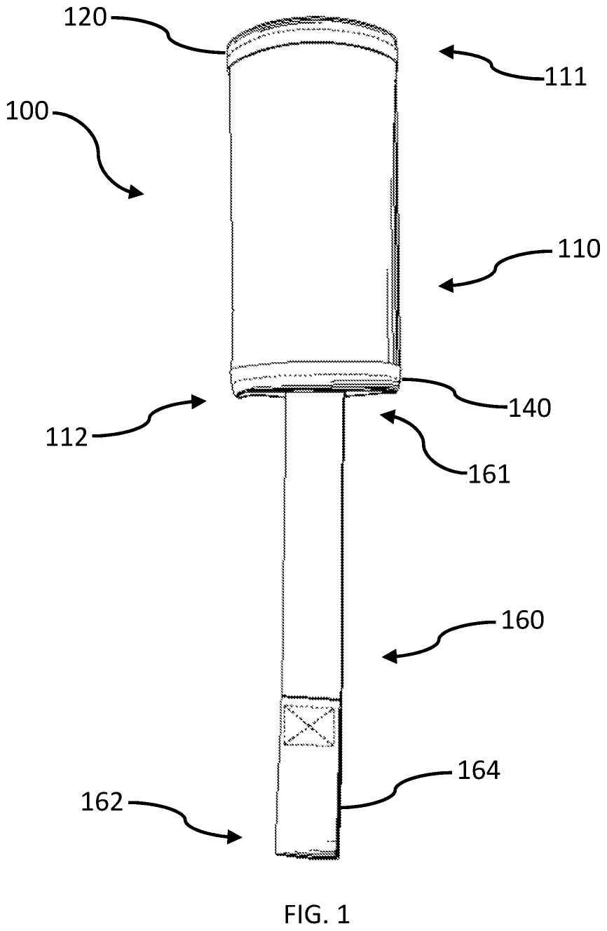

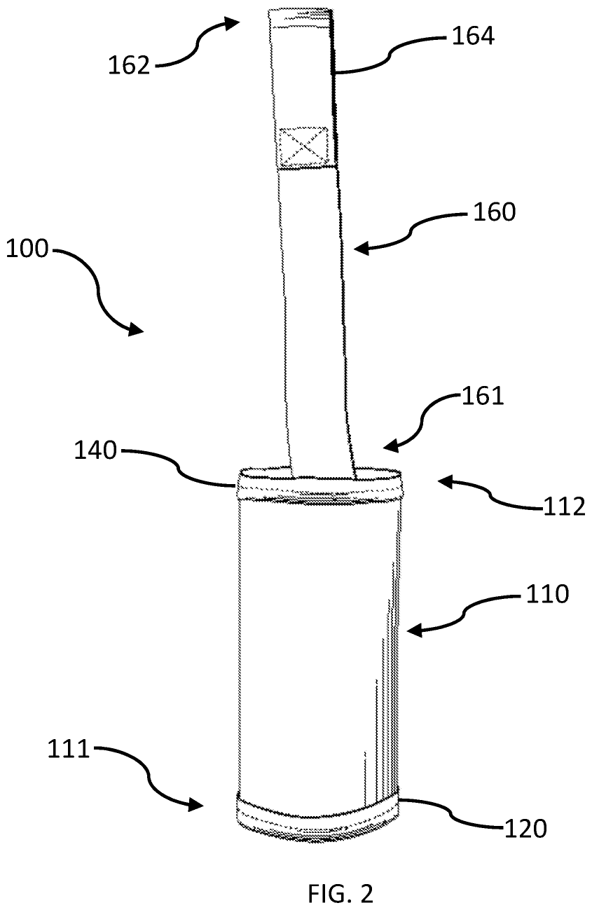

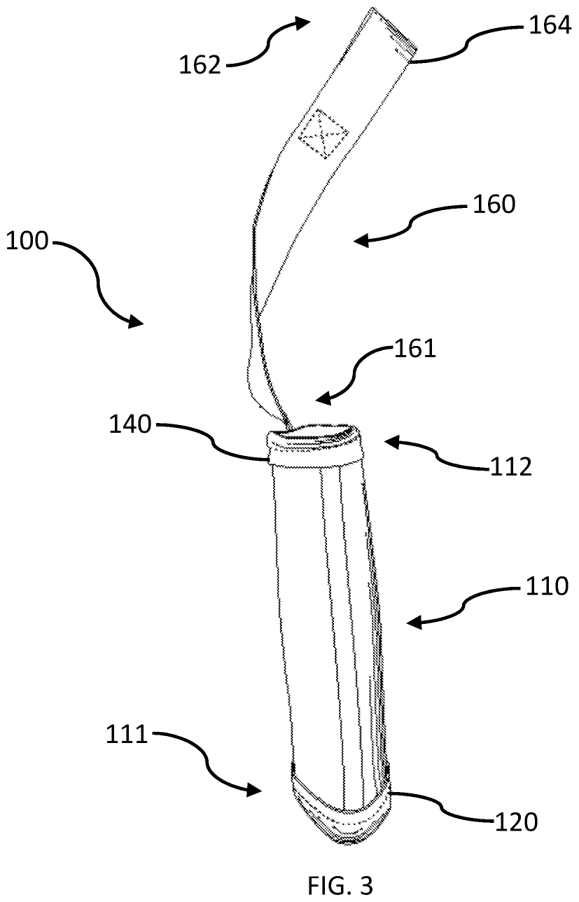

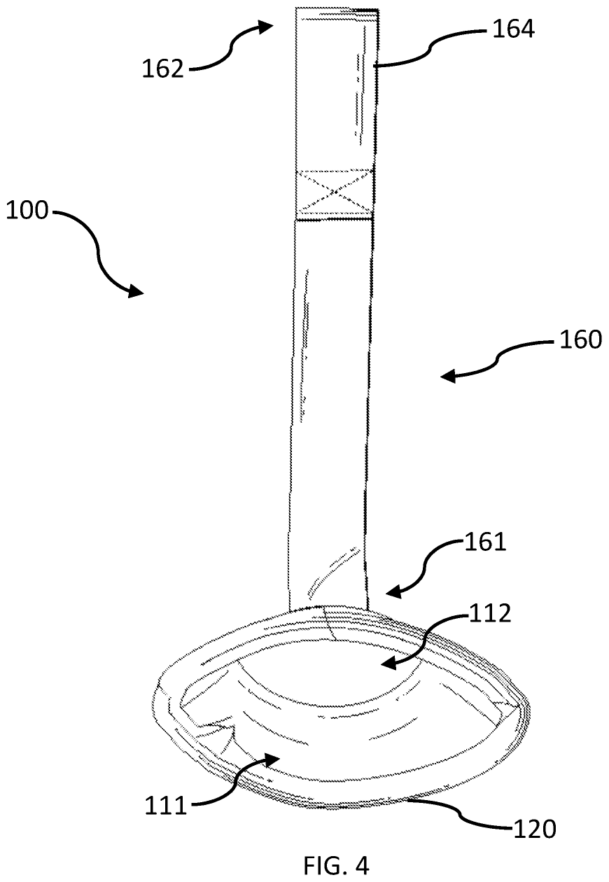

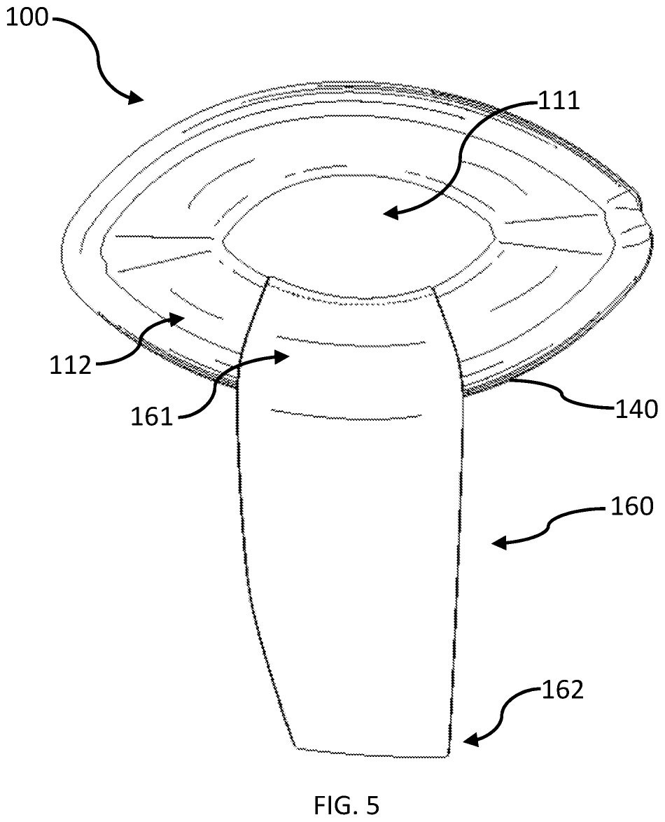

FIGS. 1-5 illustrate an emergency door lock 100. Emergency door lock 100 is configured to partially surround a door closer arm, for example, by surrounding an elbow of a door closer arm and a length of each of first and second links of the door closer arm.

Emergency door lock 100 includes a sleeve 110 with a length between a first end 111 having a first edge and a second end 112 having a second edge. Sleeve 110 may take the form of a flexible tube with open first and second ends. Sleeve 110 may be configured with folds in its perimeter so as to enable resting in a flattened or partially flattened state.

A first binding 120 wraps the first edge and a second binding 140 wraps the second edge. In an example, first and second bindings 120 and 140 are formed from nylon webbing. While the nylon webbing may be provided in any of a variety of dimensions suitable for providing first and second bindings 120 and 140 to the first and second edges, in an example, the nylon webbing is about 1.5″ wide and, as dictated by the perimeters of the first and second edges, is between about 10″ and about 19″ long.

Fastened to or adjacent to at least one of first and second ends 111 and 112 is a strap 160 extending from a strap proximal end 161 to a strap distal end 162. Strap 160 further includes a loop 164 at distal end 162. While strap 160 may be formed from any of a variety of materials suitable for transmitting a tensile force to sleeve 110, in an example, strap 160 is formed from nylon webbing. While strap 160 may take any of a variety of dimensions suitable to provide remote access to sleeve 110, in an example, strap 160 is about 1.5″ wide and 12″ long.

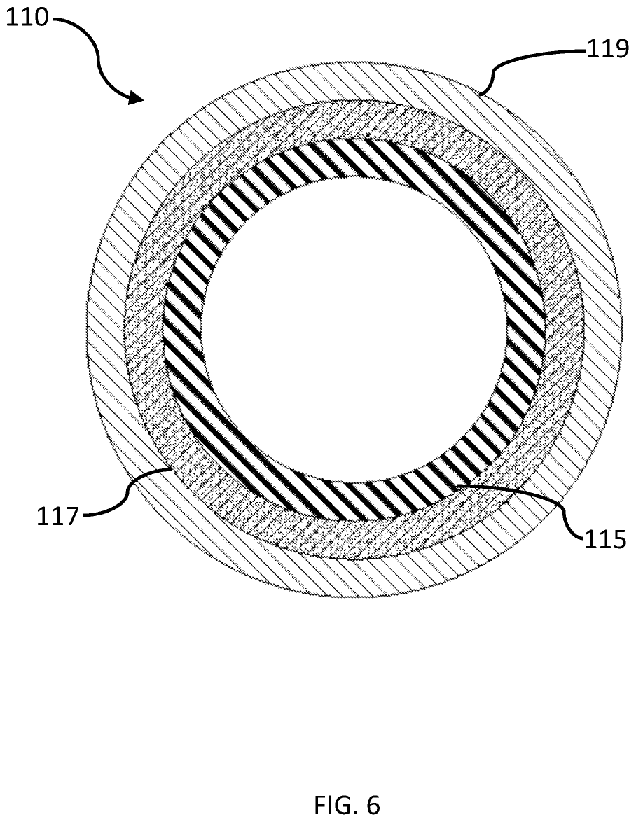

Referring to FIG. 6, sleeve 110 may include several layers. In an example, sleeve 110 includes an interior elastomeric layer 115 and a first exterior woven layer 117 surrounding interior elastomeric layer 115. In a further example, the layers also include a second exterior woven layer 119 surrounding first exterior woven layer 117.

In an example, sleeve 110 is configured to withstand pressures of at least 600 psi. While sleeve 110 may take any of a variety of dimensions suitable for locking a door by constraining an associated door closer, in an example, sleeve 110 is between about 8″ and about 9″ long and is between about 3.5″ and about 6″ in diameter. Dimensions may vary in accordance with the dimensions of the door closer to be constrained.

While elastomeric layer 115 may be formed from any of a variety of materials suitable for resisting sliding relative to a door closer, in an example, elastomeric layer 115 includes a rubber. While first exterior woven layer 117 may be formed from any of a variety of techniques suitable for resisting internal pressures of the sleeve 110, in an example, first exterior woven layer 117 includes warp yarns and filler yarns. While the warp yarns may be formed from any of a variety of materials suitable for weaving and for resisting internal pressures of the sleeve 110, in an example, the warp yarns include spun polyester or filament nylon. While the filler yarns may be formed from any of a variety of materials suitable for weaving and for providing abrasion resistance to sleeve 110, in an example, the filler yarns include filament nylon.

The emergency door lock 100 may be manufactured in accordance with any of a variety of methods. In an example method for manufacturing an emergency door lock, a number of segments are cut from a fire hose and a pull strap is coupled to the fire hose. Each of the segments cut has a first end with a first edge and a second end with a second edge. The pull strap is coupled to the fire hose adjacent to at least one of the first and second edges with a proximal end coupled with an inner surface of the segment or with an outer surface thereof. The method may further include wrapping a first binding around the first edge and stitching the first binding to the fire hose and wrapping a second binding around the second edge and stitching the second binding to the fire hose. The fire hose from which the segments are cut may be new and/or unused such that it does not include carcinogens, excludes carcinogens or is otherwise substantially free from carcinogens.

Another method for manufacturing an emergency door lock includes providing a sleeve having a length between a first end having a first edge and a second end having a second edge and, adjacent to at least one of the first and second ends, fastening a strap which extends from a strap proximal end to a strap distal end. The sleeve may be provided with an internal surface having a coefficient of friction with metals of 0.6 or higher. The method may further include wrapping the first edge with a first binding, stitching the first binding to the sleeve, wrapping the second edge with a second binding and stitching the second binding to the sleeve.

Fastening the strap may be performed by fastening a strap formed from nylon webbing. The method may further include forming a loop at the distal end of the strap. The loop may be formed by folding the strap and stitching the distal end of the strap to an intermediate point of the strap.

The sleeve may be provided by coupling a number of material layers. The layers may be coupled by inserting an elastomeric layer into an exterior woven layer. Further, the layers may be coupled by inserting a first exterior woven layer into a second exterior woven layer and inserting an interior elastomeric layer into the first exterior woven layer. The elastomeric layer inserted may be a rubber layer.

The first exterior woven layer into which the interior elastomeric layer is inserted may be formed from woven warp and filler yarns. The warp yarns may be formed from spun polyester or filament nylon while the filler yarns may be formed from filament nylon.

Disclosed emergency door locks may be used in accordance with any of a variety of methods for locking a door.

In an example method for locking a door in an emergency, after a segment of fire hose is picked up from a resting position, an elbow of a door closer arm is surrounded with the segment. The segment is advanced along both of first and second links of the door closer arm. The segment may be advanced along the first and second links until the separation distance therebetween exceeds the internal diameter of the segment of fire hose. In some cases, the segment may be advanced sufficiently far that the trailing end is beyond the elbow such that the sleeve does not cover the elbow.

With the segment of fire hose, an increase of angle between the first and second links of the door closer arm is resisted if not prevented thereby securing the door against swinging open. Because both the door closer and the fire hose are on the inside of the door, a would-be intruder on the outside could not access either the fire hose or the door closer to break the lock.

In another example method for locking a door in an emergency, an elbow of a door closer arm operatively coupled between the door and a structural element is surrounded with a sleeve having a length between a first end with a first edge and a second end with a second edge. The sleeve with which the elbow of the door closer arm is surrounded may have a first binding wrapping the first edge and a second binding wrapping the second edge.

The sleeve may have an interior elastomeric layer and a first exterior woven layer surrounding the interior elastomeric layer. The sleeve may have an interior elastomeric layer, a first exterior woven layer and a second exterior woven layer surrounding the first exterior woven layer.

The sleeve with which the elbow of the door closer arm is surrounded may have a rubber layer and a first exterior woven layer surrounding the rubber layer. The sleeve may have an interior elastomeric layer and warp yarns and filler yarns surrounding the interior elastomeric layer. The sleeve may have an interior elastomeric layer surrounded by warp yarns formed from spun polyester or filament nylon. The sleeve may have an interior elastomeric layer surrounded by filler yarns formed from filament nylon.

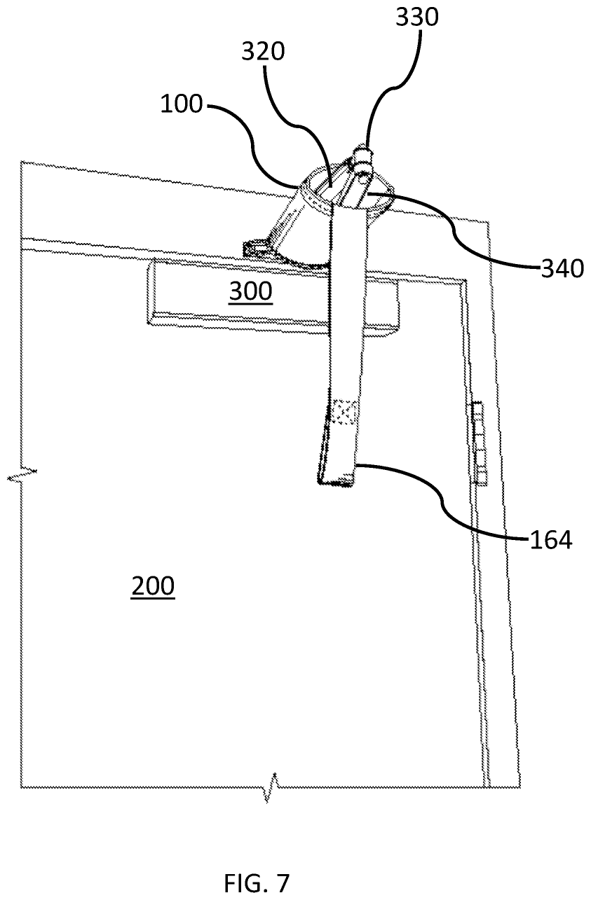

FIG. 7 illustrates an example emergency door lock 100 in use to lock an example door 200. The sleeve is advanced along both the first 320 and second 340 segments of the door closer arm 300. The sleeve may be advanced until both the first and second edges of the sleeve are between the elbow 320 and the door 200. With the sleeve, an increase of angle between the first and second links 320 and 340 of the door closer arm is resisted. Resisting the increase of angle provides resistance against opening of the door 200.

Disclosed emergency door locks may be used in accordance with any of a variety of methods for emergency response.

An example method includes, with a door closed, surrounding an elbow of a door closer arm with a sleeve having a length between a first end having a first edge and a second end having a second edge, advancing the sleeve along both of first and second segments of the door closer arm and, with the sleeve, resisting an increase of angle between the first and second segments of the door closer arm.

Subsequently, the sleeve may be withdrawn from the door closer arm by retracting along the first and second segments of the door closer arm. The sleeve may be retracted along the first and second segments by pulling a strap extending from a strap proximal end at a position adjacent to at least one of the first and second ends to a strap distal end. The strap may be pulled to remove the sleeve from the elbow of the door closer arm. Further, the strap may be pulled by gripping a loop at the distal end of the strap. The strap pulled may include nylon webbing.

The actions described above with respect to methods for manufacturing, methods for locking a door and methods for emergency response are only illustrative and other alternatives can also be provided where one or more actions are added, one or more actions are removed, or one or more actions are provided in a different sequence without departing from the scope of the claims herein.

Embodiments of the disclosure are susceptible to being used for various purposes, including, though not limited to, enabling users to, with a few simple movements, quickly lock a door in a way that cannot easily be overcome by force.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim disclosed features are intended to be construed in a non-exclusive manner, namely allowing for items, components or elements not explicitly described also to be present. Reference to the singular is also to be construed to relate to the plural.

What is claimed is:

1. An emergency door lock, comprising:
a sleeve having a length between a first end having a first edge and a second end having a second edge; and
fastened adjacent to at least one of the first and second ends, a strap extending from a strap proximal end to a strap distal end.

2. The emergency door lock as set forth in claim 1, wherein the sleeve is configured to partially surround a door closer arm.

3. The emergency door lock as set forth in claim 1, wherein the sleeve is configured to surround an elbow of a door closer arm and a length of each of first and second segments of the door closer arm.

4. The emergency door lock as set forth in claim 1, wherein the sleeve is configured to resist an increase of angle between first and second links of a door closer arm.

5. The emergency door lock as set forth in claim 1, further comprising a first binding wrapping the first edge and a second binding wrapping the second edge.

6. The emergency door lock as set forth in claim 1, wherein the strap further comprises a loop at the distal end.

7. The emergency door lock as set forth in claim 1, wherein the sleeve further comprises a plurality of layers.

8. The emergency door lock as set forth in claim 7, wherein the layers further comprise an interior elastomeric layer and a first exterior woven layer surrounding the interior elastomeric layer.

9. The emergency door lock as set forth in claim 8, wherein the layers further comprise a second exterior woven layer surrounding the first exterior woven layer.

10. A method for manufacturing an emergency door lock, comprising:
from a fire hose, cutting a plurality of segments each having a first end with a first edge and a second end with a second edge; and
coupling a pull strap to the fire hose adjacent to at least one of the first and second edges.

11. The method for manufacturing as set forth in claim 10, further comprising wrapping a first binding around the first edge and stitching the first binding to the fire hose and wrapping a second binding around the second edge and stitching the second binding to the fire hose.

12. The method as set forth in claim 10, wherein the fire hose is new.

13. The method as set forth in claim 10, wherein the fire hose includes no carcinogens.

14. A method for manufacturing an emergency door lock, comprising:
providing a sleeve having a length between a first end having a first edge and a second end having a second edge; and
adjacent to at least one of the first and second ends, fastening a strap which extends from a strap proximal end to a strap distal end.

15. The method as set forth in claim 14, further comprising wrapping the first edge with a first binding and wrapping the second edge with a second binding.

16. The method as set forth in claim 14, further comprising forming a loop at the distal end of the strap.

17. The method as set forth in claim 14, wherein providing the sleeve further comprises coupling a plurality of layers.

18. The method as set forth in claim 17, wherein coupling the layers further comprises inserting an interior elastomeric layer into a first exterior woven layer.

19. The method as set forth in claim 17, wherein coupling the layers further comprises inserting a first exterior woven layer into a second exterior woven layer.

20. The method as set forth in claim 19, wherein coupling the layers further comprises inserting an interior elastomeric layer into the first exterior woven layer.
